(19) United States
(12) Patent Application Publication
(10) Pub. No.: US 2026/0171531 A1
(43) Pub. Date: Jun. 18, 2026

(54) ENERGY SUPPLY DEVICE AND POWER TOOL HAVING SUCH AN ENERGY SUPPLY DEVICE

(71) Applicant: Hilti Aktiengesellschaft, Schaan (LI)

(72) Inventors: Markus HARTMANN, Mauerstetten (DE); Robert STANGER, Kaufbeuren (DE)

(21) Appl. No.: 18/707,823

(22) PCT Filed: Nov. 10, 2022
(86) PCT No.: PCT/EP2022/081488

§ 371 Date: May 6, 2024

(30) Foreign Application Priority Data
Dec. 1, 2021 (EP) 21211578.6

(51) Int. Cl. H01M 10/6235; H01M 10/613; H01M 10/617; H01M 10/643; H01M 10/652; H01M 10/6551

(52) U.S. Cl. CPC H01M 10/6235; H01M 10/613; H01M 10/617; H01M 10/643; H01M 10/652; H01M 10/6551

(57) ABSTRACT

An energy supply device for a power tool, wherein the energy supply device comprises at least one cell. The at least one cell has a nominal capacity of at least 1.5 ampere hours, as well as a surface area A and a volume V. The surface area A of the at least one cell is greater than eight times the cube root of the square of the volume V of the at least one cell. In addition, a ratio of resistance and surface area of the at least one cell is less than 0.2 millionm/cm². A power tool having a energy supply device is also provided.

The present invention relates to an energy supply device for a power tool, wherein the energy supply device comprises at least one cell. In a second aspect, the invention relates to a power tool having an energy supply device.

### BACKGROUND OF THE INVENTION

The invention is situated in the technical field of power tools. In this technical field, increasing use is being made of cordless power tools which are supplied with electrical energy or current via energy supply devices, such as storage batteries or rechargeable batteries. The energy supply devices of the power tools usually have battery packs with cylindrical cells which are inexpensive to manufacture and can be manufactured in standardized sizes.

Storage batteries or rechargeable batteries of power tools are usually designed to provide an application-specific capacity in the unit ampere hours (Ah) in the most economical way possible. Common applications in the field of power tools are limited to short working or operating periods and small to medium powers.

### SUMMARY OF THE INVENTION

It is an object of the present invention to provide an energy supply device, in particular for a power tool, which can also be used for longer working or operating periods and higher power ranges. A particular concern is to provide an energy supply device that is thermally robust to high heating levels, where such heating levels can be harmful both to the individual cells of the energy supply device and to the plastic parts of the energy supply device.

Power tools that are intended to be used for heavy work on a construction site, for example, have a high power requirement which can be associated with a high discharge current of the energy supply device. With such high discharge currents, conventional, for example cylindrical, cells of the energy supply device may heat up considerably. However, such heating is undesirable because, on the one hand, effort is required to dissipate the heat. On the other hand, insufficient heat dissipation can lead to damage to the energy supply device. In this respect, a potential hazard for a user and a risk for the operation of the power tool can result.

For example, DE 21 2012 000 140 U1 discloses an electric power tool that is supplied with electrical energy by means of a rechargeable battery. The battery has at least one battery cell of the 14500 type, i.e. the battery cell described in DE 21 2012 000 140 U1 has a cylindrical shape with a diameter of approximately 14 mm or less and a height of approximately 50 mm or less.

An object on which the present invention is based is that of overcoming the above-described defects and drawbacks of the prior art and of providing an energy supply device in which the heating inside the energy supply device can be reduced. In addition, an intention is to specify a power tool having a corresponding energy supply device.

The invention provides an energy supply device for a power tool, wherein the energy supply device comprises at least one cell. The at least one cell has a nominal capacity of at least 1.5 ampere hours, as well as a surface area A and a volume V. The surface area A of the at least one cell is greater than eight times the cube root of the square of the volume V of the at least one cell. In addition, a ratio of resistance and surface area of the at least one cell is less than 0.2 milliohm/cm². The expression that the surface area A of the at least one cell is greater than eight times the cube root of the square of the volume V can preferably also be expressed by the formula A>8*V\hat{ }(⅔). Written another way, this relationship can be described in that the ratio A/V of surface area to volume is greater than ten times the inverse of the cube root of the volume.

The inventors have recognized that, in the case of conventional energy supply devices, as are known from the prior art, high levels of heating can be attributed in particular to high internal resistances of the individual cells of the energy supply device.

In order to reduce this internal resistance, the invention proposes using those cells within an energy supply device in which the surface area A of at least one cell within the energy supply device is greater than eight times the cube root of the square of the volume V of the at least one cell. Tests made it possible to show that energy supply devices in which this relationship between the surface area and the volume of the at least one cell of the energy supply device is satisfied can be cooled significantly more effectively than the cells in conventional energy supply devices. The reduction in the internal resistance advantageously leads to considerably improved thermal properties of the energy supply device. In particular, the invention can be used to provide a solution to supplying a battery-operated or storage battery-operated power tool having an energy supply device according to the invention with a high output power over a long period of time without damaging the surrounding plastic components or the cell chemistry within the cells of the energy supply device.

Cell geometries which satisfy the relationship according to the invention of A>8*V\hat{ }(⅔) advantageously have a particularly favorable ratio between the outer surface of the cell, which is critical for the cooling effect, and the cell volume. The inventors have recognized that the ratio of surface area to volume of the at least one cell of the energy supply device has an important influence on the removal of heat from the energy supply device. The improved cooling capability of the energy supply device can advantageously be achieved by increasing the cell surface area given a constant volume and a low internal resistance of the at least one cell. It is preferred in the context of the invention for a low cell temperature given a simultaneously high power output to preferably be able to be rendered possible when the internal resistance of the cell is reduced. Reducing the internal resistance of the at least one cell can result in less heat being generated. In addition, a low cell temperature can by using cells in which the surface area A of at least one cell within the energy supply device is greater than eight times the cube root of the square of the volume V of the at least one cell. As a result, in particular the output of heat to the surrounding area can be improved.

Provision is made in the context of the invention for the at least one cell of the energy supply device to have a surface area A and a volume V, wherein a ratio A/V of surface area to volume is greater than eight times the inverse of the cube root of the volume. The expression that the surface area A of the at least one cell is greater than eight times the cube root of the square of the volume V can preferably also be expressed by the formula A>8*V\hat{ }(⅔). It can be preferred in the context of the invention for the ratio A/V of surface area to volume to be greater than ten times the inverse of the cube root of the volume.

It has been found that cells which satisfy said relationship can output heat to a surrounding medium significantly more effectively than the cells of conventional energy supply devices with, for example, cylindrical cells. The above relationship can be satisfied, for example, by virtue of the fact that, although the cells of the energy supply device have a cylindrical basic shape, additional elements that increase the surface area are arranged on the surface thereof. In other words, the at least one cell can have at least one element for increasing the surface area of the cell. It is very particularly preferred in the context of the invention for the at least one cell to have a multiplicity of elements that increase the surface area. Said elements can be, for example, fins, teeth or the like. Cells which do not have a cylindrical basic shape, but rather are shaped entirely differently, can also be used within the scope of the invention. For example, the cells of the energy supply device can have a substantially cuboidal or cube-like basic shape. The term “substantially” is not unclear to a person skilled in the art here because a person skilled in the art knows that, for example, a cuboid with indentations or rounded corners and/or edges should also be covered by the term “substantially cuboidal” in the context of the present invention.

In a preferred refinement of the invention, the surface area A of the at least one cell can be greater than ten times the cube root of the square of the volume V of the at least one cell.

The energy supply device has a nominal capacity of at least 1.5 ampere hours (Ah). Tests have shown that energy supply devices with a nominal capacity of more than 1.5 Ah are particularly well suited to use of powerful power tools in the construction industry and meet the requirements for availability of electrical energy and possible periods of use of the power tool particularly well there.

Here, the nominal capacity of the energy supply device is preferably measured at room temperature. The discharge current is preferably 10 A, wherein the discharging preferably ends at 2.5 V and charging preferably ends at 4.2 V. The cell is charged in accordance with the CCCV mode, wherein the abbreviation “CCCV” stands for constant current/constant voltage and is familiar to a person skilled in the art. The charging current here is preferably 0.5 C or 0.75 A, followed by a constant voltage phase up to 50 milliamperes (“constant voltage”).

Plotting the discharge capacity in relation to the discharge current shows that nominal capacity values of more than 1.5 Ah are achieved. The nominal capacity values of more than 1.5 Ah are achieved in particular at discharge current values of greater than 15 amperes.

It has been found that the storage capacity or the capacity of the energy supply device or its cells with respect to electrical energy is dependent on the volume of the active material. As the active material, cells can comprise, for example, graphite or graphite-silicon as anode material and at least one metal oxide as cathode material. The at least one cathode material can preferably be Li, Ni, Mn, Co or Al oxides, or a mixture thereof. It has been found that typical specific capacities of the anode material are >180 mAh/g and of the cathode material are >350 mAh/g.

It is preferred in the context of the invention for no 14500-type battery cells to be used in energy supply devices for power tools. Rather, the battery cells which are used in the energy supply device are characterized in that the cells have a nominal capacity of at least 1.5 ampere hours, as well as a surface area A and a volume V, wherein the surface area A of the cells is greater than eight times the cube root of the square of the volume V of the cells, and wherein a ratio of resistance and surface area of the cells is less than 0.2 millionm/cm². Therefore, the invention specifically differs from 14500-type battery cells that are “customary in domestic applications”. It has been found that energy supply devices with said combination of features have particularly favorable heat emission properties. As a result, overheating of the energy supply device can be effectively prevented.

It is preferred in the context of the invention for the term “surface” to be understood to mean a maximum, enveloping casing surface of an object. In the context of the present invention, this can mean, in particular, that the surface area of a body or an object is interpreted as the sum of its boundary surfaces. In the context of the invention, the term “volume” is preferably understood to mean that space which is enclosed by the maximum, enveloping casing surface of the object.

In particular, owing to the measures, energy supply devices with particularly small ratios of resistance to surface area A of an individual cell of the energy supply device and resistance to volume V of an individual cell of the energy supply device can be provided. It is preferred in the context of the invention for a ratio of a resistance of the at least one cell to a surface area A of the at least one cell to be less than 0.2 milliohm/cm², preferably less than 0.1 milliohm/cm² and most preferably less than 0.05 milliohm/cm². In the case of a cylindrical cell, the surface of the cell can be formed, for example, by the outer surface of the cylinder as well as the top side and the bottom side of the cell. In the context of the invention, the term “resistance” preferably denotes the internal resistance DCR_I which can preferably be measured in accordance with standard IEC61960.

Furthermore, it may be preferred in the context of the invention for a ratio of a resistance of the at least one cell to a volume V of the at least one cell to be less than 0.4 milliohm/cm³, preferably less than 0.3 milliohm/cm³ and most preferably less than 0.2 milliohm/cm³. For conventional geometric shapes, such as cuboids, cubes, spheres or the like, a person skilled in the art knows the formulae for calculating the surface area or the volume of such a geometric body.

It is preferred in the context of the invention for the at least one cell to have an internal resistance DCR_I of less than 10 milliohms (mohm). In preferred refinements of the invention, the internal resistance DCR_I of the at least one cell can be less than 8 milliohms and preferably less than 6 milliohms. Here, the internal resistance DCR_I is preferably measured in accordance with standard IEC61960. The internal resistance DCR_I represents, in particular, the resistance of a cell of the energy supply device, wherein any contributions of components or accessories of the cell to the internal resistance are not taken into account. A low internal resistance DCR_I is advantageous since in this way smaller amounts of undesired heat, which has to be dissipated, are produced. The internal resistance DCR_I is, in particular, a DC resistance which can be measured in the interior of a cell of the energy supply device. The internal resistance DCR_I can of course also assume intermediate values such as 6.02 milliohms; 7.49 milliohms; 8.33 milliohms; 8.65 milliohms or 9.5 milliohms.

It has been found that, with the internal resistance DCR_I of the at least one cell of less than 10 milliohms, it is possible to provide an energy supply device which has particularly good thermal properties in the sense that it can be operated particularly well at low temperatures, wherein the cooling expenditure can be kept surprisingly low. In particular, the energy supply device is particularly well suited to supplying electrical energy to particularly powerful power tools. The energy supply device can therefore make a valuable contribution to allowing use of storage battery-operated power tools even in areas of application that those skilled in the art previously assumed were not accessible to storage battery-operated power tools.

It is preferred in the context of the invention for the at least one cell to have a heating coefficient of less than 1.0 W/(Ah·A), preferably less than 0.75 W/(Ah·A) and particularly preferably of less than 0.5 W/(Ah·A). Furthermore, the at least one cell can be designed to output a current of greater than 1000 amperes/liter substantially constantly. The discharge current is indicated in relation to the volume of the at least one cell, wherein the volumetric measurement unit “liter” (I) is used as the unit for the volume. The cells according to the invention are therefore able to output a discharge current of substantially constantly greater than 1000 A per liter of cell volume. In other words, a cell with a volume of 1 liter is able to output a substantially constant discharge current of greater than 1000 A, wherein the at least one cell furthermore has a heating coefficient of less than 1.0 W/(Ah·A). In preferred refinements of the invention, the at least one cell of the energy supply device can have a heating coefficient of less than 0.75 W/(Ah·A), preferably less than 0.5 W/(Ah·A). The unit for the heating coefficient is watts/(ampere hours. amperes). The heating coefficient can of course also have intermediate values, such as 0.56 W/(Ah·A); 0.723 W/(Ah·A) or 0.925 W/(Ah·A).

The invention advantageously makes it possible to provide an energy supply device having at least one cell which exhibits reduced heating and therefore is particularly well suited to supplying power tools in which high powers and high currents, preferably constant currents, are desired for operation. In particular, the invention can be used to provide an energy supply device for a power tool in which the heat which is optionally created during operation of the power tool and when outputting electrical energy to the power tool can be dissipated in a particularly simple and uncomplicated manner. Tests have shown that the invention can not only be used to more effectively dissipate existing heat. Rather, the invention prevents heat being generated or the quantity of heat generated during operation of the power tool can be considerably reduced using the invention. The invention can advantageously be used to provide an energy supply device which can supply electrical energy in an optimum manner primarily also to power tools which have stringent requirements in respect of power and discharge current. In other words, the invention can provide an energy supply device for particularly powerful power tools with which heavy drilling or demolition work can be performed on construction sites for example.

The combination of the low heating coefficient with the high constant current output can advantageously be achieved by an optimal cell geometry in which, for example, the ratio of the number of internal-cell current collectors in relation to the capacity is as high as possible. This advantageously means that an internal resistance of the at least one cell can be reduced.

In the context of the invention, the term “power tool” should be understood to mean a typical piece of equipment that can be used on a construction site, for example a building construction site and/or a civil engineering construction site. They may be hammer drills, chisels, core drills, angle grinders or cut-off grinders, cutting devices or the like, without being restricted thereto. In addition, auxiliary devices such as those occasionally used on construction sites, such as lamps, radios, vacuum cleaners, measuring devices, construction robots, wheelbarrows, transport devices, feed devices or other auxiliary devices can be “power tools” in the context of the invention. The power tool may in particular be a mobile power tool, wherein the energy supply device may also be used in particular in stationary power tools, such as frame-mounted drills or circular saws. However, preference is given to hand-held power tools that are, in particular, operated using a storage battery or battery.

It is preferred in the context of the invention for the at least one cell to have a temperature cooling half-life of less than 12 minutes, preferably less than 10 minutes, particularly preferably less than 8 minutes. In the context of the invention, this preferably means that, with free convection, a temperature of the at least one cell is halved in less than 12, 10 or 8 minutes. The temperature cooling half-life is preferably determined in an inoperative state of the energy supply device, that is to say when the energy supply device is not in operation, that is to say is not connected to a power tool. Energy supply devices with temperature cooling half-lives of less than 8 mins have primarily been found to be particularly suitable for use in powerful power tools. The temperature cooling half-life can of course also have a value of 8.5 minutes, 9 minutes 20 seconds or of 11 minutes 47 seconds.

Owing to the surprisingly low temperature cooling half-life of the energy supply device, the heat generated during operation of the power tool or when it is charging remains within the at least one cell only for a short time. In this way, the cell can be recharged particularly quickly and is rapidly available for re-use in the power tool. Moreover, the thermal loading on the components of the energy supply device or the power tool having the energy supply device can be considerably reduced. As a result, the energy supply device can be preserved and its service life extended.

In the context of the invention, it is preferred for the at least one cell to be arranged in a battery pack of the energy supply device. A series of individual cells can preferably be combined in the battery pack and in this way inserted into the energy supply device in an optimum manner. For example, 5, 6 or 10 cells can form a battery pack, with integer multiples of these numbers also being possible. For example, the energy supply device can have individual cell strings which can comprise, for example, 5, 6 or 10 cells. An energy supply device having, for example, three strings of five cells each can comprise, for example, 15 individual cells. The energy supply device shown as an exemplary embodiment in FIG. 1 has eighteen cells, for example, which are arranged in three strings.

It is preferred in the context of the invention for the at least one cell to comprise an electrolyte, wherein the electrolyte is preferably present in a liquid physical state at room temperature. The electrolyte can comprise lithium, sodium and/or magnesium, without being restricted thereto. In particular, the electrolyte can be lithium-based. As an alternative or in addition, said electrolyte can also be sodium-based. It is also conceivable for the storage battery to be magnesium-based. The electrolyte-based energy supply device can have a rated voltage of at least 10 V, preferably at least 18 V, in particular of at least 28 V, for example 36 V. A rated voltage in a range of from 18 to 22 V, in particular in a range of from 21 to 22 V, is very particularly preferred. The at least one cell of the energy supply device can have, for example, a voltage of 3.6 V, without being restricted thereto.

It is preferred in the context of the invention for the at least one cell to have a cell core, wherein no point within the cell core is more than 5 mm away from a surface of the energy supply device. When the energy supply device is discharged, for example when it is connected to a power tool and work is performed with the power tool, heat can be produced in the cell core. In this specific refinement of the invention, this heat can be transported on a comparatively short path as far as the surface of the cell of the energy supply device. The heat can be dissipated in an optimum manner from the surface. Therefore, such an energy supply device can exhibit good cooling, in particular comparatively good self-cooling. The time period until the limit temperature is reached can be extended and/or the situation of the limit temperature being reached can advantageously be entirely avoided. As a further advantage of the invention, a relatively homogeneous temperature distribution can be achieved within the cell core. This can result in uniform aging of the storage battery. This can in turn increase the service life of the energy supply device.

It is preferred in the context of the invention for the term “cell core” to be understood to mean the center of gravity of an object, here preferably of the battery cell. Therefore, a shortest distance between the enveloping surface of the battery cell and the center of gravity in a preferred refinement of the invention is preferably at most 5 mm. In other words, in a preferred embodiment of the invention, the cell core and the casing surface or surface of the battery cell do not lie further than 5 mm apart.

It is preferred in the context of the invention for the at least one cell to have a maximum constant current output of greater than 20 amperes, preferably greater than 30 amperes, most preferably greater than 40 amperes. The maximum constant current output is the quantity of current of a cell or an energy supply device that can be drawn without the cell or the energy supply device reaching an upper temperature limit. Possible upper temperature limits can lie in a region of 60° C. or 70° C., without being restricted thereto. The unit for the maximum constant current output is amperes.

All intermediate values should also always be considered to be disclosed in the case of all the value ranges that are mentioned in the context of the present invention. For example, values of between 20 and 30 A, that is to say 21, 22.3, 24, 25.55 or 27.06 amperes etc. for example, should also be considered to be disclosed in the case of the maximum constant current output. Furthermore, values of between 30 and 40 A, that is to say 32, 33.3, 36, 38.55 or 39.07 amperes etc. for example, should also be considered to be disclosed.

It is preferred in the context of the invention for the energy supply device to have a discharge C rate of greater than 80·t\hat{ }(−0.45), where the letter “t” stands for time in the unit seconds. The C rate advantageously allows quantification of the charging and discharge currents for energy supply devices, wherein the discharge C rate used here renders possible, in particular, the quantification of the discharge currents of energy supply devices. For example, the maximum permissible charging and discharge currents can be indicated by the C rate. These charging and discharge currents preferably depend on the rated capacity of the energy supply device. The unusually high discharge C rate of 80·t\hat{ }(−0.45) advantageously means that the energy supply device can be used to achieve particularly high discharge currents which are required for operating powerful power tools in the construction industry. For example, the discharge currents can lie in a region of greater than 40 amperes, preferably greater than 60 amperes or even more preferably greater than 80 amperes.

In the context of the invention, it is preferred for the cell to have a cell temperature gradient of less than 10 kelvin. The cell temperature gradient is preferably a measure of temperature differences within the at least one cell of the energy supply device, wherein it is preferred in the context of the invention for the cell to have a temperature distribution that is as uniform as possible, that is to say for a temperature in an inner region of the cell to differ as little as possible from a temperature which is measured in the region of a casing surface or outer surface of the cell.

In a second aspect, the invention relates to a power tool having a energy supply device. The terms, definitions and technical advantages introduced for the energy supply device preferably apply in an analogous manner to the power tool.

### BRIEF DESCRIPTION OF THE DRAWINGS

Further advantages will become apparent from the following description of the figures. The figure, the description and the claims contain numerous features in combination. A person skilled in the art will expediently also consider the features individually and combine them to form useful further combinations.

Identical and similar components are denoted by the same reference signs in the figure, in which:

FIG. 1 shows a schematic side view of a preferred refinement of the energy supply device

FIG. 2 shows a schematic side view of a power tool with a preferred refinement of the energy supply device

FIG. 3 shows a schematic illustration of a preferred refinement of a cell of the energy supply device

### DETAILED DESCRIPTION

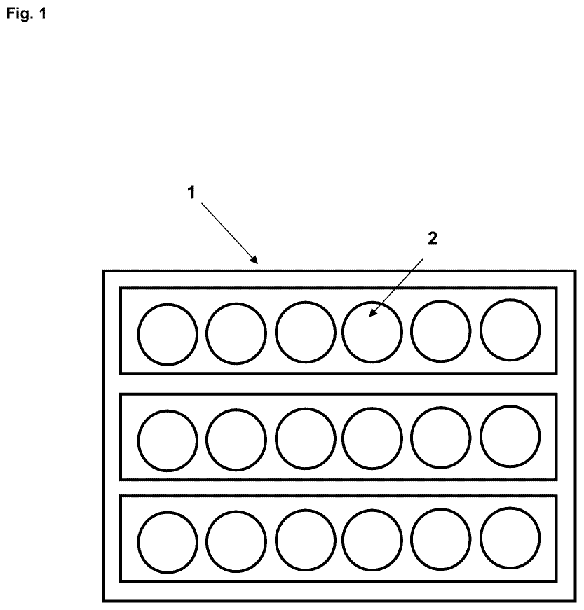

FIG. 1 shows a schematic side view of a preferred refinement of the energy supply device 1. The energy supply device 1 illustrated in FIG. 1 has eighteen cells 2, the eighteen cells 2 being arranged in three strings within the energy supply device 1. In particular, the cells 2 are symbolized by the circles, while the strings are symbolized by the elongated rectangles surrounding the circles (“cells 2”).

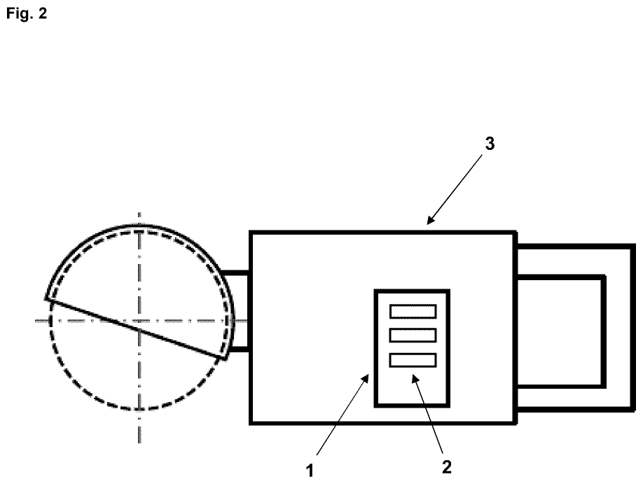

FIG. 2 shows a schematic view of a power tool 3 having a energy supply device 1. The power tool 3 can be a cut-off grinder, for example, which has a cut-off wheel as a tool. The power tool 3 can have a grip which is designed, for example, as a rear handle. In addition, the power tool 3 can have operating elements, such as switches or buttons, in a manner known per se. In addition, the power tool 3 can have a motor which can represent a load and can be supplied with electrical energy by the energy supply device 1.

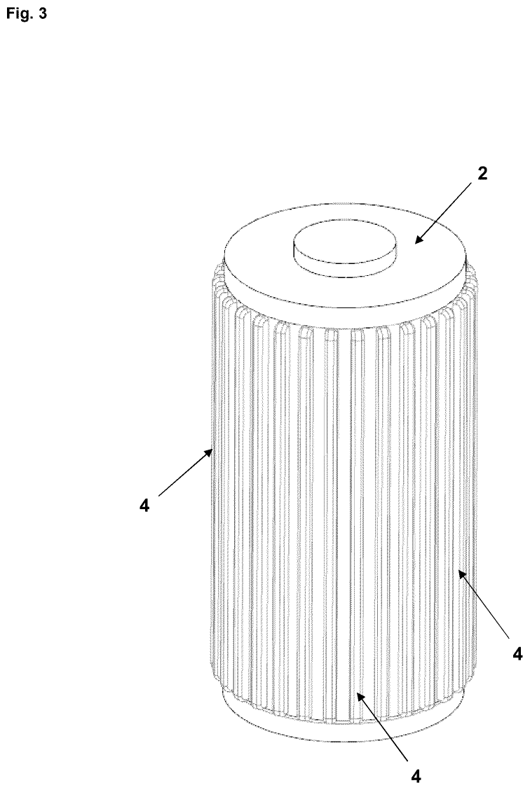

FIG. 3 shows a schematic illustration of a preferred refinement of a cell 2 of the energy supply device 1. The cell 2 has a top side and a bottom side, wherein a cylinder with a casing surface extends between the top side and the bottom side of the cell 2. The surface area A of the cell 2 can be formed, for example, by forming the sum of the areas of the top side, the bottom side and the casing surface. The volume V of the cell 2 results from multiplying the base area, for example the bottom side of the cell 2, by the height h of the cylinder that characterizes the outer shape of the cell 2.

Elements 4 can be arranged on the surface A of the cell 2, wherein the elements 4 increase the surface area A of the cell 2. Providing such elements 4 that increase the surface area makes it possible, for example, to modify a cylindrical cell of a conventional energy supply device 1, as is known from the prior art, such that the modified cell 2 satisfies the relationship according to the invention A>8*V\hat{ }(⅔). Of course, the relationship according to the invention A>8*V\hat{ }(⅔) can also be satisfied in many other ways. The elements 4 that increase the surface area can be, for example, fins, teeth, ribs, patterns or other structures, without being restricted thereto. The elements 4 that increase the surface area advantageously increase the surface area A of the at least one cell 2 of the energy supply device 1, such that unwanted heat can be better dissipated from an interior of the energy supply device 1.

### LIST OF REFERENCE SIGNS

1 Energy supply device
2 Cell
3 Power tool
4 Element that increases the surface area

What is claimed is:

1-12. (canceled)

13. An energy supply device for a power tool, the energy supply device comprising:
at least one cell, the at least one cell having a nominal capacity of at least 1.5 ampere hours, as well as a surface area A and a volume V, wherein the surface area A is greater than eight times the cube root of the square of the volume V of the at least one cell, and wherein a ratio of resistance and the surface area A of the at least one cell is less than 0.2 milliohm/cm² .

14. The energy supply device as recited in claim 13 wherein the ratio of resistance and the surface area A is less than 0.1 milliohm/cm².

15. The energy supply device as recited in claim 14 wherein the ratio of resistance and the surface area A is less than 0.05 milliohm/cm².

16. The energy supply device as recited in claim 13 wherein a ratio of a resistance of the at least one cell to the volume V is less than 0.4 milliohm/cm.

17. The energy supply device as recited in claim 16 wherein the ratio of the resistance of the at least one cell to the volume V is less than 0.3 milliohm/cm.

18. The energy supply device as recited in claim 17 wherein the ratio of the resistance of the at least one cell to the volume V is less than 0.2 milliohm/cm.

19. The energy supply device as recited in claim 13 wherein the at least one cell has an internal resistance DCR_I of less than 10 milliohms.

20. The energy supply device as recited in claim 19 wherein the internal resistance DCR_I is less than 8 milliohms.

21. The energy supply device as recited in claim 20 wherein internal resistance DCR_I is less than 6 milliohms.

22. The energy supply device as recited in claim 13 wherein the at least one cell has a heating coefficient of less than 1.0 W/(Ah·A).

23. The energy supply device as recited in claim 22 wherein the heating coefficient is less than 0.75 W/(Ah·A).

24. The energy supply device as recited in claim 23 wherein the heating coefficient is less than 0.50 W/(Ah·A).

25. The energy supply device as recited in claim 13 wherein the at least one cell is designed to output a current of greater than 1000 amperes/liter substantially constantly.

26. The energy supply device as recited in claim 13 wherein the at least one cell has a maximum constant current output of greater than 20 amperes.

27. The energy supply device as recited in claim 26 wherein the maximum constant current output is greater than 30 amperes.

28. The energy supply device as recited in claim 27 wherein the maximum constant current output of greater than 40 amperes.

29. The energy supply device as recited in claim 13 wherein the energy supply device has a discharge C rate of greater than 80·t\acute{ }(−0.45).

30. The energy supply device as recited in claim 13 wherein the at least one cell has a cell temperature gradient of less than 10 kelvin.

31. The energy supply device as recited in claim 13 wherein the at least one cell has a cell core, wherein no point within the cell core is more than 5 mm away from a surface of the energy supply device.

32. The energy supply device as recited in claim 13 wherein the at least one cell has at least one element for increasing the surface area A of the cell.

33. A power tool comprising the energy supply device as recited in claim 13.
